(19) United States
(12) Patent Application Publication
(10) Pub. No.: US 2007/0280419 A1
(43) Pub. Date: Dec. 6, 2007

(54) RADIOGRAPHIC IMAGING SYSTEM

(75) Inventor: Kazuhiko KURASHIKI, Kaisei-machi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/749,424

(22) Filed: May 16, 2007

(30) Foreign Application Priority Data
May 31, 2006 (JP) 2006-152421

(51) Int. Cl. H05G 1/64

(52) U.S. Cl. 378/98.2

(57) ABSTRACT

A radiographic imaging system prevents an error in the correspondence between the image data generated from a recording medium and the information on imaging even under the condition where a medical terminal and a radiographic image reading apparatus are operated by different operators in separate rooms. The system includes: a medical terminal for storing information on plural imagings performed by using a radiographic imaging apparatus and transmitting the information on plural imagings; and a radiographic image reading apparatus for sequentially displaying the information on plural imagings according to an order of receiving the information, displaying, when a recording medium in which radiographic images have been recorded is inserted, a confirmation screen for confirmation of information on imaging, and reading, after an operator confirms the information on imaging, the radiographic images recorded in the recording medium and associating the generated image data with the information on imaging.

### BACKGROUND OF THE INVENTION

1. Field of the Invention

The present invention relates to a radiographic imaging system for performing imaging by applying radiation to a subject, reading resulting radiographic images recorded in a recording medium, generating image data, and displaying or outputting medical diagnostic images based on the image data.

2. Description of a Related Art

Conventionally, an imaging method using radiation (X-ray, α-ray, β-ray, γ-ray, electron ray, ultraviolet ray, or the like) is utilized in various fields, and particularly, in the medical field, the imaging method is one of the most important means for diagnoses. Since the first X-ray photography was implemented, the X-ray photography method has been repeatedly improved, and a method using a combination of fluorescent screen and X-ray film is in the mainstream at present. On the other hand, in recent years, various digitalized apparatuses such as X-ray CT, ultrasonic diagnostic apparatus, MRI, and soon have been put to practical use, and construction of a diagnostic information processing system within hospitals has been promoted. Many studies have been made for digitalizing X-ray images, and a radiographic imaging method using photostimulable phosphor has been established and attracted attention as a replacement for the conventional X-ray photography.

The photostimulable phosphor (storage phosphor) is a material that, when applied with radiation, part of the radiation energy is stored therein, and then, applied with excitation light such as visible light, photostimulated luminescence is generated depending on the stored energy, and the existence has been conventionally known. The radiographic imaging method using the photostimulable phosphor is a method of imaging and recording radiographic images of a subject such as a human body on a sheet where photostimulable phosphor has been applied by using a radiographic imaging apparatus or CR (computed radiographic) apparatus, photoelectrically reading photostimulated luminescence light generated when the photostimulable phosphor sheet is scanned with excitation light such as a laser beam, and thereby, obtaining image data. Furthermore, after appropriate processing of image data by using an image processing apparatus, the radiographic images may be displayed as visible images by being outputted onto a display such as a CRT or printed on films by using a laser printer or the like.

Such radiographic imaging method offers performance comparable to the conventional X-ray photography in imaging sensitivity and image quality. For example, in comparison with the conventional X-ray photography, the radiographic imaging method provides an extremely wider exposure range and the response of photostimulated luminescence light to exposure is nearly proportional over the entire exposure range. Accordingly, regardless of radiation dose used when imaging a subject, the luminescence range where an image exists can be captured and normalized into digital signals without excess or deficiency. Good quality images can be provided even under various imaging conditions by performing image processing such as normalization and frequency processing on the image data obtained as described above according to conditions defined for diagnostic purposes. Furthermore, since the image data that has been directly digitalized is obtained, deterioration in image quality is hardly caused, a large amount of image data can be stored for a long period, and further, the development toward a medical diagnostic information system can be realized.

Further, in order to store image data as medical practice data, information on imaging such as patient information and examination information is set as image incidental information associated with images. Generally, information on imaging is registered before imaging by using a console for controlling the radiographic imaging apparatus, a medical terminal such as an image processing apparatus for performing processing on the obtained images, and so on. For example, when a barcode is used for associating the information on imaging with the image data, an operator selects the information on imaging in an examination to be performed at the next time on a menu screen displayed on the medical terminal, allows a barcode reader of the medical terminal to read the barcode attached to a cassette that contains a photostimulable phosphor sheet, and thereby, the information on imaging and the barcode information are registered in association with each other.

The cassette is set in the radiographic imaging apparatus, and radiographic imaging is performed. Furthermore, when a radiographic image recorded on the photostimulable phosphor sheet is read by using a radiographic image reading apparatus, the barcode attached to the cassette is read by the barcode reader of the radiographic image reading apparatus, the read barcode information is transmitted to the medical terminal together with the generated image data. In the medical terminal, the match between the barcode information read by the barcode reader of the radiographic image reading apparatus and the registered barcode information is detected, and thus, the image data and the information on imaging are associated with each other.

However, for an operator who is not proficient in operation of the radiographic imaging system, the operation is not intuitive and hard to handle. In conventional systems, an error occurs when an imaging menu is not selected in advance in the medical terminal or the cassette is set in the radiographic image reading apparatus without registration of the barcode information, and therefore, there has been a problem that it is difficult for the operator to find the next thing to do.

As a related technology, Japanese Patent Application Publication JP-P2005-342195A discloses a radiographic imaging system that can be operated relatively easily by even an operator having little experience and low proficiency. The radiographic imaging system includes (i) a medical terminal for sequentially receiving information on plural imagings to be performed by using a radiographic imaging apparatus for applying radiation to a subject and recording resulting radiographic images in a recording medium, storing the information on plural imagings in the order of receiving, and transmitting the information on plural imagings in the order of storing, and (ii) a radiographic image reading apparatus for reading the recorded radiographic images to generate image data according to the order of receiving the information on plural imagings from the medical terminal when the recording medium for which imaging has been performed in correspondence with the information on each imaging is set, associating the generated image data with the information on the imaging, and transmitting them to the medical terminal.

However, under the condition where the radiographic image reading apparatus and the medical terminal are operated by different operators in separate rooms, when an examination that requires radiographic image reading is changed by the operator of the medical terminal, there is a possibility that the operator of the radiographic image reading apparatus does not recognize it and sets a wrong recording medium in the radiographic image reading apparatus, and an error may occur in the correspondence between the image data generated from the recording medium and the information on imaging.

### SUMMARY OF THE INVENTION

Accordingly, in view of the above-mentioned points, a purpose of the present invention is to provide a radiographic imaging system which prevents an error in the correspondence between the image data generated from a recording medium and the information on imaging even under the condition where a medical terminal and a radiographic image reading apparatus are operated by different operators in separate rooms.

In order to achieve the above-mentioned purpose, a radiographic imaging system according to one aspect of the present invention includes: a medical terminal for storing information on plural imagings to be performed by using a radiographic imaging apparatus, which performs imaging by applying radiation on a subject and records resulting radiographic images in a recording medium, and transmitting the information on plural imagings; and a radiographic image reading apparatus for sequentially displaying the information on plural imagings on a display unit according to an order of receiving the information on plural imagings from the medical terminal, displaying, when the recording medium in which the radiographic images have been recorded is inserted, a confirmation screen for confirmation of information on imaging on the display unit, and reading, after an operator confirms the information on imaging, the radiographic images recorded in the recording medium to generate image data and associating the generated image data with the information on imaging.

According to the present invention, when the recording medium in which the radiographic images have been recorded is inserted, the radiographic image reading apparatus displays a confirmation screen for confirmation of information on imaging on the display unit to seek confirmation of the operator, there is little possibility that an error occurs in the correspondence between the image data generated from the recording medium and the information on imaging.

### BRIEF DESCRIPTION OF THE DRAWINGS

FIG. 1 is a block diagram showing a configuration of a radiographic imaging system according to one embodiment of the present invention;

FIG. 2 is a block diagram showing a detailed configuration of a medical terminal shown in FIG. 1;

FIG. 3 is a flowchart showing an operation example of the radiographic imaging system shown in FIG. 1;

FIG. 4 shows an example of information screen displayed on a display unit of a radiographic image reading apparatus; and

FIG. 5 shows an example of confirmation screen displayed on the display unit of the radiographic image reading apparatus.

### DESCRIPTION OF THE PREFERRED EMBODIMENTS

Hereinafter, preferred embodiments of the present invention will be explained in detail with reference to the drawings. The same reference numerals will be assigned to the same component elements and the description thereof will be omitted.

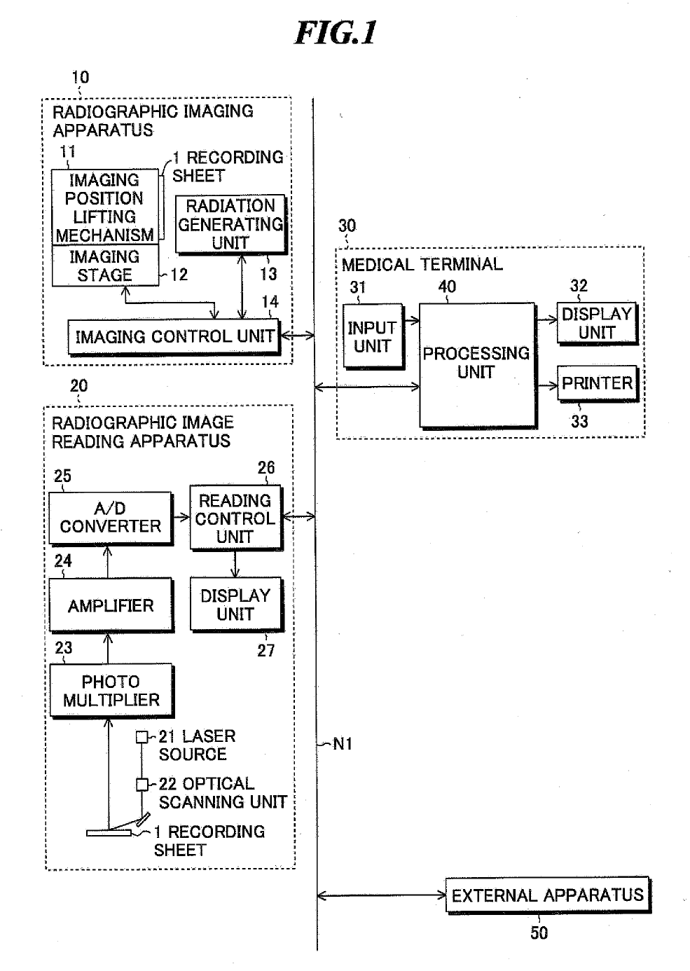

FIG. 1 is a block diagram showing a configuration of a radiographic imaging system according to one embodiment of the present invention. As shown in FIG. 1, the radiographic imaging system includes a radiographic imaging apparatus 10 for performing imaging by applying radiation to a subject and recording resulting radiographic images in a photostimulable phosphor sheet (recording sheet), a radiographic image reading apparatus 20 for photoelectrically reading information of the radiographic images and so on recorded on the recording sheet 1 and generating image data, and a medical terminal 30 for storing information on plural imagings to be performed by using the radiographic imaging apparatus 10, which are connected to network N1. Furthermore, according to need, an external apparatus 50 such as a database server, ID card reader, or electronic chart/receipt computer is connected to the network N1.

Here, as the medical terminal 30, a console to be used for controlling the radiographic imaging apparatus 10, an image processing apparatus for receiving image data from the radiographic image reading apparatus 20 and performing various kinds of processing thereon to display or output images, a terminal to be used for registration of patient information, examination information and so on, and an apparatus having the combined function of them may be used.

The recording sheet 1 to be used for radiographic imaging is a sheet applied with a photostimulable phosphor material, and information on a subject is recorded thereon by being applied with radiation. The recording sheet 1 is contained in the cassette for use.

The radiographic imaging apparatus 10 includes an imaging position lifting mechanism 11 for moving the imaging position of the subject up and down by moving the position of the cassette containing the recording sheet 1 up and down, an imaging stage 12 where the position of feet of the subject is determined, a radiation generating unit 13 for applying radiation to the subject, and an imaging control unit 14 for controlling the radiation generating unit 13 and so on according to preset imaging conditions. Radiographic imaging of the subject is performed under the preset imaging condition and resulting radiographic images are recorded on the recording sheet 1.

After imaging, the cassette containing the recording sheet 1 is inserted into the radiographic image reading apparatus 20, and the recording sheet 1 is loaded and placed in a predetermined position. In the radiographic image reading apparatus 20, a light beam outputted from a laser source 21 passes through an optical scanning unit 22 to scan the surface of the recording sheet 1 placed in the predetermined position. The light beam is applied to the recording sheet 1 by the scanning, and photostimulated luminescence light is generated from the point, to which the light beam is applied, in an amount of light according to radiographic image information that has been accumulated and recorded. The photostimulated luminescence light is photoelectrically detected by a photomultiplier 23 and outputted as an analog signal. The analog signal is amplified by an amplifier 24, and digitalized by an A/D converter 25. Thus generated image data is inputted to the medical terminal 30 via a reading control unit 26 and the network N1.

The medical terminal 30 includes an input unit 31 to be used for inputting various commands, information on imaging and so on, a display unit 32 for displaying operation screens and radiographic images, a printer 33 for printing radiographic images on films or the like, and a processing unit 40. Information on imaging includes patient information such as patient ID or patient name, and examination information such as examination ID or imaging menu. The information on imaging may be transmitted from the external apparatus 50 to the medical terminal 30 via the network N1. The processing unit 40 stores inputted information on plural imagings and transmits the information at least to the radiographic image reading apparatus 20, and receives image data transmitted by the radiographic image reading apparatus 20 and performs processing thereon.

In the embodiment, the information on plural imagings stored in the medical terminal 30 is transmitted to a reading control unit 26 of the radiographic image reading apparatus 20, and the reading control unit 26 allows a display unit 27 to sequentially display information screens that show information on the respective imagings according to the order of receiving the information on imagings. On the information screen, one or some of patient IDs, patient names, and imaging menus may be displayed, for example. Thereby, an examination that requires imaging is provided to the operator, and, after the imaging of a radiographic image by using the radiographic imaging apparatus 10, the operator inserts a cassette storing the recording sheets on which the radiographic images have been recorded. In this way, the operator becomes able to perform intuitive operation.

Further, under the condition where the radiographic image reading apparatus 20 and the medical terminal 30 are operated by different operators in separate rooms, when an examination that requires radiographic image reading is changed by the operator A of the medical terminal 30, there is a possibility that the operator B of the radiographic image reading apparatus 20 does not recognize it and inserts a wrong cassette into the radiographic image reading apparatus 20, and an error may occur in the correspondence between the image data generated from the recording medium 1 and the information on imaging.

In this regard, when the operator B inserts a cassette into the radiographic image reading apparatus 20, the reading control unit 26 allows the display unit 27 to display a confirmation screen for confirmation of the information on imaging with respect to the examination that requires radiographic image reading. After the operator B confirms the information on imaging displayed on the display unit 27, the reading control unit 26 controls the respective units to read the radiographic image recorded on the recording sheet 1 placed in the predetermined position and generate image data, and associates the generated image data with the information on imaging and transmits them to the medical terminal 30. In this way, the error in the correspondence between the image data generated from the recording medium 1 and the information on imaging can be eliminated even when the examination that requires radiographic image reading is changed by the operator A.

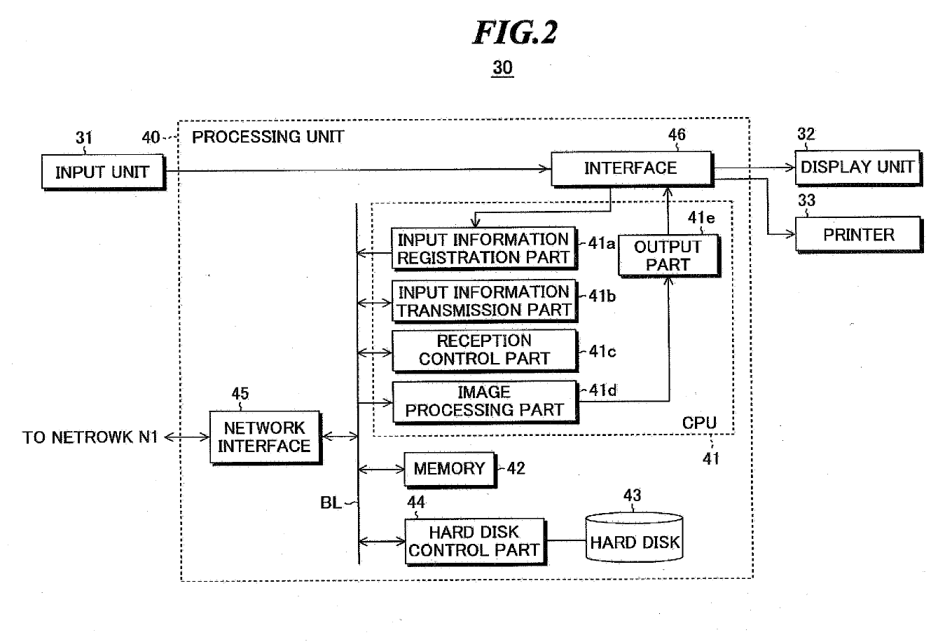

FIG. 2 is a block diagram showing a detailed configuration of the medical terminal shown in FIG. 1. The processing unit 40 of the medical terminal 30 includes a central processing unit (hereinafter, referred to as CPU) 41 connected to the input unit 31, the display unit 32 and so on via an interface 46, a memory 42 for temporarily storing the information on imagings inputted by using the input unit 31 or transmitted from the external apparatus 50 (FIG. 1), image data received from the radiographic image reading apparatus 20 and so on, a hard disk 43 as a recording medium, a hard disk control part 44 for controlling the hard disk 43, and a network interface 45. These parts 41 to 45 are connected to one another via bus line BL.

The CPU 41 is connected to the radiographic imaging apparatus 10 and the radiographic image reading apparatus 20 shown in FIG. 1 via the network interface 45 and the network N1. Further, in the hard disk 43, software (programs) for allowing the CPU 41 to perform operation is recorded. As the recording medium, not only the built-in hard disk 43, but also an external hard disk, flexible disk, MO, MT, RAM, CD-ROM, DVD-ROM, or the like may be used.

Next, functional blocks 41a to 41e formed by the CPU 41 and the software (programs) will be explained.

The input information registration part 41a stores and registers the information on imaging inputted by using the input unit 31 or transmitted from the external apparatus 50 (FIG. 1) together with information representing the order of being inputted or transmitted (the order of registration) in the memory 42. Here, the operator A of the medical terminal 30 (e.g., a doctor who requests radiographic imaging) can change the order of registration as needed for placing priority on emergency imaging.

Further, the input information transmission part 41b transmits the information on plural imagings stored in the memory 42 to the radiographic image reading apparatus 20 according to the order of registration.

The reading control unit 26 of the radiographic image reading apparatus 20 shown in FIG. 1 receives the information on plural imagings and allows the display unit 27 to display an information screen that shows at least part of the information on imagings (e.g., patient IDs, patient names, and imaging menus on the most recent two examinations). The operator B in charge of imaging (e.g., imaging technician) places a cassette in the radiographic imaging apparatus 10 and performs imaging of radiographic images according to the patient ID, patient name, and imaging menu contained in the information screen displayed on the display unit 27.

When the operator B inserts the cassette detached from the radiographic imaging apparatus 10 into the radiographic image reading apparatus 20, the reading control unit 26 allows the display unit 27 to display a confirmation screen for confirmation of the information on imaging with respect to the examination that requires radiographic image reading. Thereby, after the operator B confirms the information on imaging, the reading control unit 26 controls the laser source 21 to A/D converter 25 to read the image information from the recording sheet 1 and generate image data, and associates the generated image data with the information on imaging, and transmits them to the medical terminal 30.

Referring to FIG. 2 again, the reception control part 41c receives the image data and information on imaging transmitted from the reading control unit 26, and associates the image data with the information on imaging and stores them in the memory 42.

The image processing part 41d performs image processing on the image data stored in the memory 42 according to the diagnostic purpose based on the preset normalization condition, frequency processing condition, or the condition contained in the information on imaging. The image-processed image data is outputted from the output part 41e to the display unit 32 via the interface 46, an image is displayed on the display unit 32, and the image is confirmed by the operator A. The image-processed image data is recorded in the hard disk 43 via the hard disk control part 44 according to the instruction of the operator A.

In the embodiment, the input information registration part 41a, the input information transmission part 41b, the reception control part 41c, the image processing part 41d, and the output part 41e are formed by the CPU and software, however, they may be formed by digital circuits or analog circuits.

Next, an operation example of the radiographic imaging system according to the embodiment will be explained with reference to FIGS. 1 to 5.

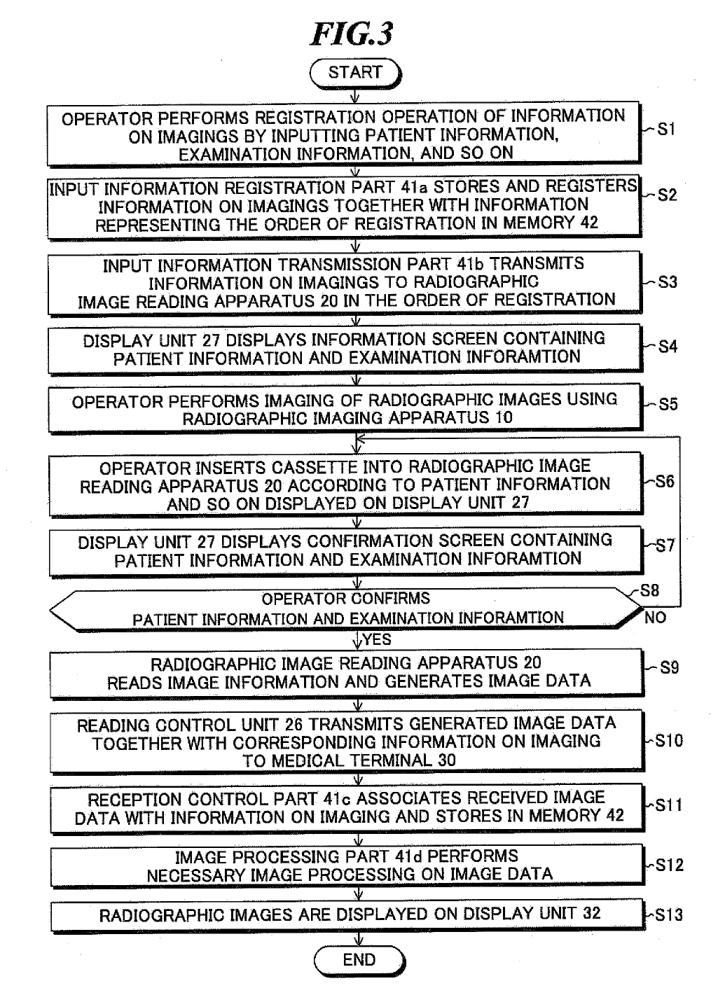

FIG. 3 is a flowchart showing the operation example of the radiographic imaging system shown in FIG. 1. First, at step S1, the operator A of the medical terminal 30 performs registration operation of the information on plural imagings by inputting patient information, examination information and soon using the input unit 31. Then, at step S2, the input information registration part 41a stores and registers the information on plural imagings together with information representing the order of being inputted (the order of registration) in the memory 42. Here, the operator A can change the order of registration as needed for placing priority on emergency imaging.

At step S3, the input information transmission part 41b transmits the information on plural imagings stored in the memory 42 to the radiographic image reading apparatus 20 according to the order of registration. At step S4, the display unit 27 of the radiographic image reading apparatus 20 displays an information screen that shows at least part of the received information on plural imagings (e.g., patient IDs, patient names, and imaging menus on the most recent two examinations). At step S5, the operator B in charge of imaging performs imaging of radiographic images according to the information screen by using the radiographic imaging apparatus 10.

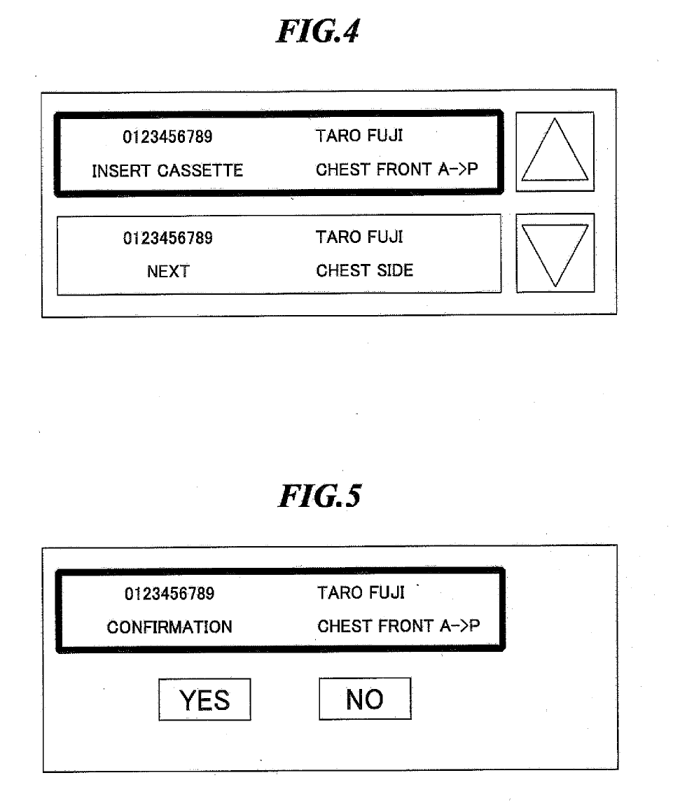

FIG. 4 shows an example of information screen displayed on the display unit of the radiographic image reading apparatus. In the embodiment, two types of information on imaging received by the reading control unit 26 are displayed in the order of being received. In the example shown in FIG. 4, the patient identification number “0123456789”, patient name “TARO FUJI”, imaging menu “CHEST FRONT A->P” contained in the first received information on imaging and the patient identification number “0123456789”, patient name “TARO FUJI”, imaging menu “CHEST SIDE” contained in the second received information on imaging are displayed with comments that state the progress of the operation.

Here, regarding the first received information on imaging, the comment “INSERT CASSETTE” that promotes the operation by the operator for radiographic image reading is displayed, and, regarding the second received information on imaging, the comment “NEXT” that shows the recording sheets of the imaging will be an object of the next radiographic image reading is displayed. Furthermore, in the information screen, in order to allow intuitive grasp of the cassette to be inserted, the first received information on imaging is enclosed with a thick frame and emphasized among the information on plural imagings for which reading of recording sheets have not yet completed.

Then, at step S6, when the operator B inserts the cassette that contains the recording sheets of the imaging according to the imaging menu “CHEST FRONT A->P” of the patient “TARO FUJI” into the radiographic image reading apparatus 20 according to the information screen displayed on the display unit 27. At step S7, as shown in FIG. 5, the reading control unit 26 allows the display unit 27 to display the confirmation screen containing the information on imaging with respect to the examination that requires radiographic image reading.

At step S8, the operator B confirms the information on imaging displayed on the display unit 27. For example, in the confirmation screen shown in FIG. 5, not only the patient identification number “0123456789”, patient name “TARO FUJI”, and imaging menu “CHEST FRONT A->P” contained in the first received information on imaging, but also “YES” button for giving a response that the information on imaging being displayed corresponds to the inserted cassette and “NO” button for giving a response that the information on imaging being displayed does not correspond to the inserted cassette.

When the operator B clicks the “YES” button with a mouse, the processing moves to step S9. On the other hand, when the operator B clicks the “NO” button with the mouse, the reading control unit 26 controls a loading mechanism to eject the inserted cassette, and the processing returns to step S6.

At step S9, the radiographic image reading apparatus 20 reads image information from the recording sheet stored in the cassette and generates image data. At step S10, the reading control unit 26 of the radiographic image reading apparatus 20 transmits the generated image data together with the information on imaging to the medical terminal 30.

At step S11, the reception control part 41c of the medical terminal 30 receives the image data and information on imaging transmitted from the radiographic image reading apparatus 20, and associates the image data with the information on imaging and stores them in the memory 42.

At step S12, the image processing part 41d performs necessary image processing on the image data stored in the memory 42. At step S13, radiographic images are displayed on the display unit 32 based on the image-processed image data, and confirmed by the operator A.

According to the embodiment, since the image data generated by reading radiographic images from the recording sheets stored in the cassette can be associated with information on imagings in the order of registration, works of selecting information on imaging to be associated with image data and reading of a barcode attached to the cassette are no longer required. Further, since the confirmation screen for confirmation of the information on imaging is displayed after the cassette is inserted into the radiographic image reading apparatus, there is little possibility for an operator who has little experience and low proficiency to make a mistake in the correspondence between cassette and examination.

In the embodiment, the medical terminal 30 transmits the information on imaging to the radiographic image reading apparatus 20, however, the radiographic image reading apparatus 20 may start access to the medical terminal 30 to acquire the information on imaging.

Further, as shown in FIG. 4, the information on imaging to be associated with the image data generated by reading radiographic images from the recording sheets may be changed by the click of the arrow button displayed on the right of the information on imaging on the display unit 27. In this case, the radiographic image reading apparatus 20 transmits the generated image data together with the changed information on imaging to the medical terminal 30. Further, in the case where plural stackers, in which cassettes are inserted and placed, are provided in the radiographic image reading apparatus 20, information on imagings may be displayed with respect to each stacker.

1. A radiographic imaging system comprising:
a medical terminal for storing information on plural imagings to be performed by using a radiographic imaging apparatus, which performs imaging by applying radiation on a subject and records resulting radiographic images in a recording medium, and transmitting the information on plural imagings; and
a radiographic image reading apparatus for sequentially displaying the information on plural imagings on a display unit according to an order of receiving the information on plural imagings from the medical terminal, displaying, when the recording medium in which the radiographic images have been recorded is inserted, a confirmation screen for confirmation of information on imaging on said display unit, and reading, after an operator confirms said information on imaging, the radiographic images recorded in said recording medium to generate image data and associating the generated image data with said information on imaging.

2. The radiographic imaging system according to claim 1, wherein said radiographic image reading apparatus displays at least one of patient ID, patient name, and imaging menu as said information on imaging on the display unit.

3. The radiographic imaging system according to claim 1, wherein said radiographic image reading apparatus reads the radiographic images recorded in said recording medium to generate image data and associates the generated image data with said information on imaging when the operator gives a response that said information on imaging displayed on the confirmation screen corresponds to said recording medium, and ejects said recording medium when the operator gives a response that said information on imaging displayed on the confirmation screen does not correspond to said recording medium.

4. The radiographic imaging system according to claim 2, wherein said radiographic image reading apparatus reads the radiographic images recorded in said recording medium to generate image data and associates the generated image data with said information on imaging when the operator gives a response that said information on imaging displayed on the confirmation screen corresponds to said recording medium, and ejects said recording medium when the operator gives a response that said information on imaging displayed on the confirmation screen does not correspond to said recording medium.
